(19) United States
(12) Patent Application Publication
(10) Pub. No.: US 2006/0112002 A1
(43) Pub. Date: May 25, 2006

(54) Method and apparatus for managing data in a business to business environment

(75) Inventors: Joseph H. Holland, Barrington, IL (US); Mark W. Byrd, Downingtown, PA (US)

Correspondence Address: MORGAN LEWIS & BOCKIUS LLP, 1111 PENNSYLVANIA AVENUE NW, WASHINGTON, DC, 20004, US

(73) Assignee: ATLAS COMMERCE, INC.

(21) Appl. No.: 11/174,576

(22) Filed: Jul. 6, 2005

Related U.S. Application Data
(63) Continuation of application No. 09/585,057, filed on Jun. 1, 2000.

(51) Int. Cl. G06Q 40/00

(52) U.S. Cl. 705/37

(57) ABSTRACT

Shown is a method and apparatus of controlling a commercial environment. The environment comprises a plurality of traders, each of the traders included in at least one of a plurality of members, wherein the plurality of members defines a community. The method comprises the steps of, defining the community, defining which members are included in the community, defining which traders are included in which members, and allowing at least one of the traders to authorize at least one of: a) interaction between a first trader and a second trader; and b) interaction between a first member and a second member.

### FIELD OF THE INVENTION

The present invention relates to business-to-business (B2B) exchanges and in particular to B2B exchanges which selectively overlap. Specifically, a method and apparatus are described for authorizing interaction within and across multiple B2B communities.

### BACKGROUND OF THE INVENTION

As the 20^{th} century has drawn to a close, the role of the Internet with regard to business transactions has reached unprecedented heights. Specifically, many businesses have found that they can operate more efficiently and with greater profitability by using the Internet to facilitate their operations. Thus, while previously many businesses would interact with each other using a variety of mediums, the Internet has now come to play an important role in allowing such businesses to communicate, grow and prosper.

An interesting structure which has been used to facilitate interaction between businesses on the Internet is known as a business-to-business (B2B) exchange. In a business-to-business exchange, a plurality of companies agree to conduct transaction with each other in a structured Internet environment. Companies that are members of a B2B exchange are thus able to request, offer, sell and buy products and services with each other. Such transactions occur in a structured environment. In many ways, because of the pre-established structure, two companies are able to transact business with each other more efficiently over the B2B exchange than using other communication avenues outside of the B2B exchange.

One reason that B2B exchanges are so useful is because they create vertical markets in which companies can transact business. Thus, each B2B exchange will attempt to play a central role within the market to which it caters. As a B2B exchange grows, it may also reach into other market areas.

AU sectors seem to be good candidates for B2B technology. Furthermore, B2B exchanges have helped to increase competition between buyers and sellers, thus leading to reduced prices, higher quality, sharing of information, and lowering of transaction cycles. While B2B exchanges have had phenomenal success, they also suffer from drawbacks. B2B exchanges, for example, may be rigid in the manner in which they are structured. Thus, it may be difficult to add or subtract one or more members from the B2B exchange. Furthermore, it may be difficult to control the transactions between members of a B2B exchange to fine levels detail.

### SUMMARY OF THE INVENTION

The present invention relates to a method and apparatus of controlling a commercial environment, the environment comprising a plurality of traders, each of the traders included in at least one of a plurality of members, wherein the plurality of members define a community. The method comprises the steps of, defining the community, defining which members are included in the community, defining which traders are included in which members, and allowing at least one of the traders to authorize at least one of a) interaction between a first trader and a second trader, and b) interaction between a first member and a second member.

### BRIEF DESCRIPTION OF THE DRAWINGS

FIG. 1 is an illustration in accordance with an exemplary embodiment of a community master data table of the present invention.

FIG. 2 is an illustration in accordance with an exemplary embodiment of a graphical user interface used to build the community master data table of the present invention.

FIG. 3 is an illustration in accordance with an exemplary embodiment of a member master data table of the present invention.

FIG. 4 is an illustration in accordance with an exemplary embodiment of a graphical user interface used to build the community master data table of the present invention.

FIG. 5 is an illustration in accordance with an exemplary embodiment of a trader master data table of the present invention.

FIG. 6 is an illustration in accordance with an exemplary embodiment of a graphical user interface used to build the trader master data table of the present invention.

FIG. 7 is an illustration in accordance with an exemplary embodiment of an item master data table of the present invention.

FIG. 8 is an illustration in accordance with an exemplary embodiment of an graphical user interface used to build the trader master data table of the present invention.

FIG. 9 is an illustration in accordance with an exemplary embodiment of a trader to community authorization data table of the present invention.

FIG. 10 is an illustration in accordance with an exemplary embodiment of a graphical user interface used to build the trader to community authorization table of the present invention.

FIG. 11 is an illustration of a trader to member authorization data table in accordance with an exemplary embodiment of the present invention.

FIG. 12 is an illustration in accordance with an exemplary embodiment of a graphical user interface used to build the trader to member authorization table of the present invention.

FIG. 13 is an illustration in accordance with an exemplary embodiment of a trader to trader authorization data table of the present invention.

FIG. 14 is an illustration in accordance with an exemplary embodiment of a graphical user interface used to build the trader to trader authorization table of the present invention.

FIG. 15 is an illustration in accordance with an exemplary embodiment of a matrix table of the present invention.

FIG. 16 is an illustration in accordance with an exemplary embodiment of a graphical user interface to authorize a trader to a matrix of the present invention.

FIG. 17 an illustration in accordance with an exemplary embodiment of a member to member authorization data table of the present invention.

FIG. 18 is an illustration in accordance with an exemplary embodiment of a graphical user interface used to build the member to member authorization table of the present invention.

FIG. 19 is a flow chart of an exemplary operation of a trader to trader view of the present invention.

FIG. 20 is a flow chart of an exemplary operation of a trader to community view of the present invention.

FIG. 21 is a flow chart of an exemplary operation of a trader to member view of the present invention.

FIG. 22 is a flow chart of an exemplary operation of maintaining item lists of the present invention.

FIG. 23 is an exemplary embodiment in accordance with a graphical user interface used to maintain lists in the present invention.

FIG. 24 is an exemplary embodiment in accordance with a graphical user interface used to perform a search in the maintain item list graphical user interface of the present invention.

### DETAILED DESCRIPTION OF THE DRAWINGS

The present invention allows a plurality of B2B exchanges to be dynamically created and modified. B2B exchanges may be thought of as being comprised of communities in which transactions occur. Each community may be defined in terms of its constituent members. Members transact business with each other through the specific acts of individual traders which act on behalf of their respective members.

Before proceeding, the following definitions may be helpful in order to understand the exemplary embodiments of the present invention.
Member: A member is an organization such as a company or a group. Members transact business with each other if such transaction is authorized. In an exemplary embodiment of the present invention, a plurality of attributes for each member are stored. Attributes may include, for example, address, form of payment, preferred shipping method, etc.
Community: A plurality of members which are able to transact business with each other form a community. Thus, for example, a community may be given an appropriate name. Members may be allowed to conduct business transaction with each other if they belong to a common community.
Trader: A trader is an individual who performs transactions on behalf of a member. Thus, a trader is an individual who plays a representative role with respect to a member for which that trader performs transactions. An example of a trader is a purchasing agent within a corporation. Another example of a trader individual broker. Each trader is given specific authorization with regard to his/her ability to interact with other traders, members and communities.

To illustrate the above definitions, assume that a community is, for example, a buying cooperative. The members of the community are the individual companies that buy and sell within the community. Traders are the individuals who place and satisfy orders on behalf of their respective members.

One more definition may be useful, namely, that of a sponsor. Each community has a sponsor. The sponsor is the organization that organizes, selectively maintains, and selectively controls the community. A sponsor of a community is also a member of the community.

In an exemplary embodiment of the present invention, it is useful to create individual definitions for each community, each member and each trader. These definitions typically include the parameters which relate to each entity. Exemplary definitions may include name, address, phone number, buying and/or selling parameters (such as credit limits), buying and/or selling groups, and the like. The parameters relating to these relationships are maintained in data tables. Exemplary embodiments of these data tables are further defined herein. Also, the relationships between the entities are desirably based on individual definitions. These parameters are also maintained in data tables, and comprise information such data as the names of the entities that the table is relating to each other as well as other data relating to maintenance of the table. Exemplary embodiments of the relationship tables are also further defined herein.

Thus, for operation of a B2B exchange in accordance with an exemplary embodiment of the present invention, it is desirable to define community, the members which are included in the community, and the traders which correspond to their respective members. A trader is authorized to allow interaction between one trader and another trader. In addition, (or alternatively), a trader may authorize interaction between one member and another member. In this manner, interactions between traders, members, or both may be flexibly defined.

In a further exemplary embodiment of the present invention, it may be desirable to designate at least one community in which the two traders are allowed to interact. By providing the ability to make such a designation, a finer level of control is created with regard to the interaction between two traders. In other words, two traders may be prohibited from interacting with each other unless they have been explicitly designated as belonging to a designated community.

An exemplary embodiment of the present invention is shown by referring to the block diagrams of community 1010 and community 1050 which is shown in FIG. 25A and FIG. 25B, respectively. Community 1010 includes member 1012, member 1016, member 1014 and member 1018. Members 1012 and 1014 may be, for example, buyers. Members 1016 and 1018 may be, for example, sellers. Member 1012 may have transactions performed on its behalf through the actions of traders 1020, 1022 and 1024. Member 1016 may have transactions performed on its behalf as a result of the actions of traders 1032, 1034 and 1036. Member 1014 may have transactions performed on its behalf through the actions of traders 1026, 1028 and 1030. Member 1018 may have actions performed on its behalf as a result of the actions of traders 1038, 1040 and 1042.

One member may be a part of more than one community. Thus, for example, in FIG. 25A, member 1012 is a buyer. In FIG. 25B, however, member 1012 is a seller. The relationship between other members is illustrated in FIG. 25A and FIG. 25B. Also note that a member can be both a buyer and a seller simultaneously within a community.

FIG. 26 is an overview of the relationships inside a community. Community 2020 comprises members 2022, 2024 traders 2026, 2028, 2030, 2032, 34, 36. Members and traders in a community communicate with each other through environment 2038. Environment 2038 may be, for example, a computer server. Environment 2038 includes transaction portion 2040 and maintenance portion 2042. Within community 2020, traders and members interact through either the transaction portion 2042 or the maintenance portion 2042. That is, if trader 2026 wishes to maintain data for trader 2032, trader 2026 will interact with trader 2032 through the data maintenance portion of environment 2038. Likewise, if trader 2026 wishes to transact with trader 2032, trader 2026 will interact through the transaction portion 2040 of environment 2038. As shown in FIG. 26, while trader 2026 may transact business with trader 2032, trader 2026 does not have an authorized line of interaction through maintenance portion 2042 to trader 2034 and therefore can not maintain data for trader 2034. In other words, should a trader or member wish to transact business with another trader or a member, they desirably interact through transaction portion 2040, and have specific authorization to do so. Likewise, should any trader or member wish to maintain data for any other trader or member, they desirably interact through the maintenance portion 2042 of the environment 2038. By requiring a trader or member within a community to have authority to use either the transaction portion 2040 or maintenance portion 2042 in order to transact with another member or trader, data maintenance and 2020 transactions within community 2020 may be controlled.

FIG. 27 represents another overview of an exemplary embodiment of the present invention. As shown in FIG. 27, a plurality of graphical user interfaces (GUIs) may be used. Each GUI provides a unique screen configuration. The screen configurations are used, for example, to show the attributes, relationships or respective authorizations of communities, members or traders. A unique GUI allows a trader to view information which a trader considers pertinent to his/her respective member. Of course, by customizing the GUI, individualized company logos and cosmetics may be implemented.

While GUIs 3032, 3034 and 3036 allow the selective display of data which is stored within database 3040, the GUIs interact with database 3040 via intermediate unit 3038. Thus, information from database 3040 is provided to GUIs 3032, 3034 and 3036 using a common format. Each GUI then selects or rearranges the data as desired for its respective trader.

Now that these terms used in describing an exemplary embodiment of the present invention have been defined, and an overview of this exemplary embodiment has been presented, it is useful to define some of the data used in the present invention, and how that data is structured. Generally, the data is structured into tables. The following are definitions of some of the tables used in this exemplary embodiment.

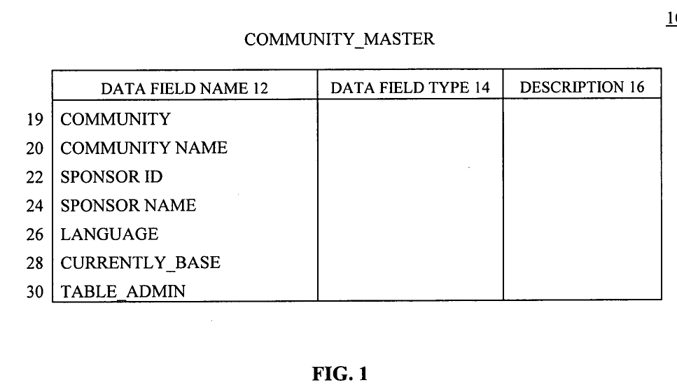

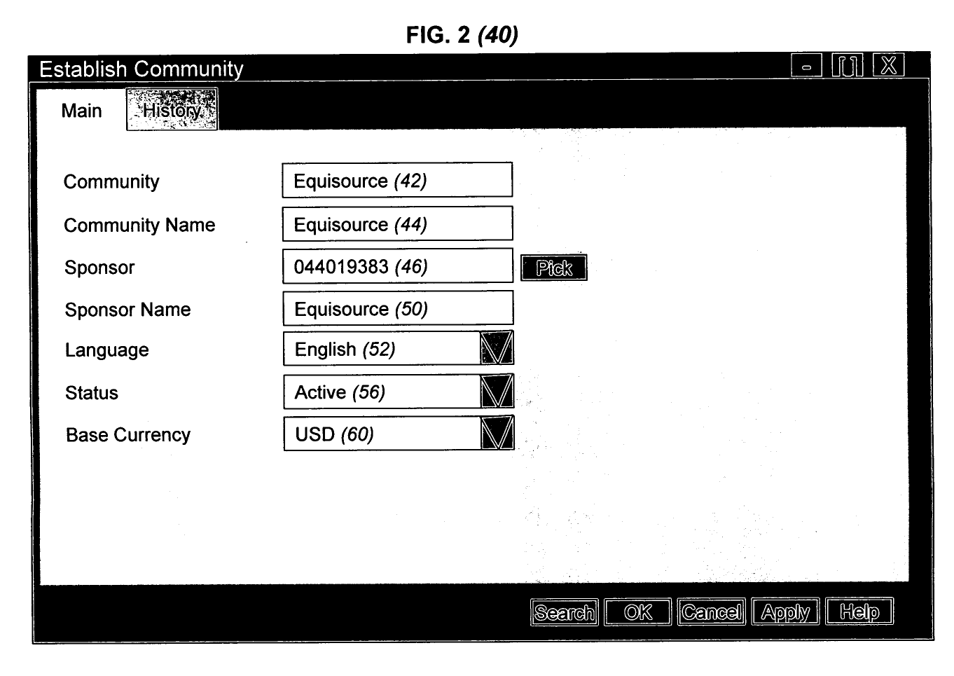

In an exemplary embodiment of the present invention, it is useful to define the community in a data trader. Turning now to FIG. 1, there is shown an exemplary embodiment of the community master table 10. This table contains a default definition of the community. As the system may function for multiple communities, multiple communities may be defined in single system.

Table 10 comprises three columns, the data field name 12, data field type 14, and date of description 16. The community ID field 18 contains a unique ID number for this community. This is the ID used by the system when ever the community is referenced. The community name field 20 contains an alpha numeric representation for the community ID. This community name may be used to reference the community to users, so that users need not remember specific community ID's. The sponsor ID field 22 contains a unique ID number for the sponsor of this community. Similar to community name, sponsor name 24 contains an alphanumeric representation of the sponsor that may be used by a user so that the user does not need to remember sponsor ID numbers. The language field 26 contains the default language that is used in this community. The system is not limited to English, but may be implemented in variety of languages. The currency base field 28 contains the base currency used in the community. As this system may be used for various languages, the system is not limited to U.S. dollars as well. The table and administration field 30 represents a plurality of fields used to administer the table. Examples of these fields are a created by field and a last modified date field.

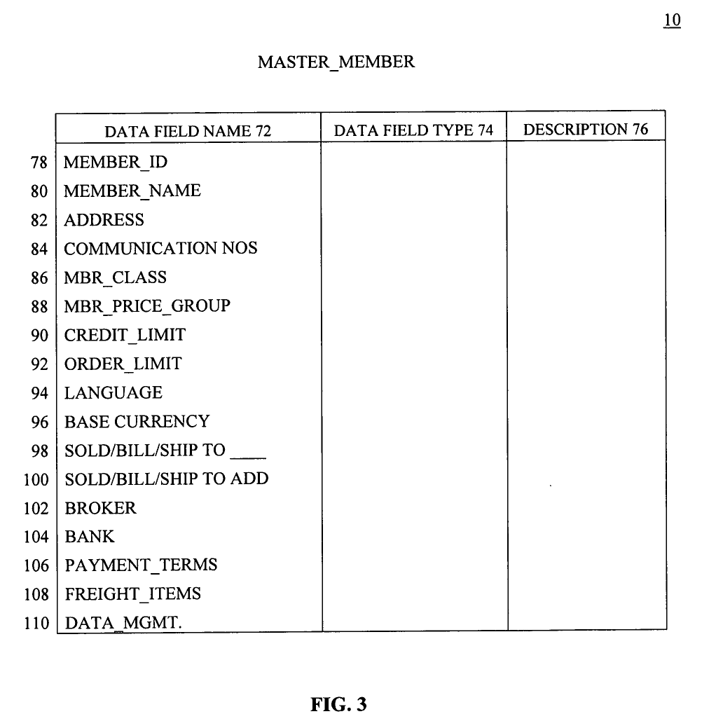

In order to create the previously defined data table in an exemplary embodiment of the present invention, it is useful to provide an interface for a user to enter data. Turning now to FIG. 2, there is shown an exemplary embodiment of a graphical user interface 40 which a trader may use to build the community table illustrated in FIG. 1. The community field 42 contains the ID of the community which is being established. This may be entered by the user of the system or may automatically entered should the user be authorized to build only one community. The community name 44 is the name associated with the community ID 42. The community sponsor 46 contains the ID of the sponsor of the community. The pick button 48 located next to the sponsor field 46 may be pressed to show a list of all sponsors which the user of the system is authorized to choose from. The sponsor name 50 is the sponsor name associated with the sponsor ID 46. The language field 52 shows the language in which this community operates. Next to the language field is a button 54 that, when pressed, will show all the possible traces for the language in this community in a drop down menu. The status field 56 will show active or inactive status. The down-arrow button 58 next to the status field 56 may be pressed to show a drop down menu with all the possible choices for the status field. The base currency field 60 shows the base currency is which the community operates. The down-arrow button 64 next to the base currency field 62 may be pressed to activate a drop down menu that contains all the possible choices for currency selection in this community.

Similar to the community master illustrated in FIG. 1, each member may be defined by parameters listed in a data table. Turning now to FIG. 3, there is shown an exemplary embodiment of the master member table 70. The table contains three columns, data field name 72, data field type 74 and description 76. The member ID field 78 contains the unique ID number for this member. The member name field 80 contains the alphanumeric representation for the member ID. A user need not remember the member ID but can use the member name to reference this particular member. The address field 82 contains the address or addresses for this member. The communication numbers field 84 represents a plurality of fields containing phone numbers, fax numbers, e-mail address etc. The member class field 86 contains a default value for the member. This field is used in certain transactions between this member and other members. The member price group field 88 contains a representation of the price group in which this member resides. This field is used to place the member in a price group for sales and/or purchases of products within the system. The credit limit field 90 is used to hold a number which represents this members credit limit. The order limit field 92 is used to hold a number which represents the limit of the number of orders this member may place. The language field 94 contains the default language this member operates in. The base currency field 96 contains the default value for the base currency used by this member. The sold, billed and ship to flag field 98 represents a plurality of fields which are used to indicate if this member is a selling member a billing member, or a ship to member. The sold, billed, shipped to address field 100 represents a plurality of fields used in connection with the flag fields 98 and contains the proper, corresponding address. The broker field 102 contains name of a broker this member may use if elected. The bank field 104 contains the name of this members default bank. The payment terms field 106 contains the default standard payment terms should this member be a buyer. The freight terms field 108 contains the default standard freight terms used by this member should this member be a buyer. The data management fields 110 represents a plurality of fields used to contain data regarding management of the table.

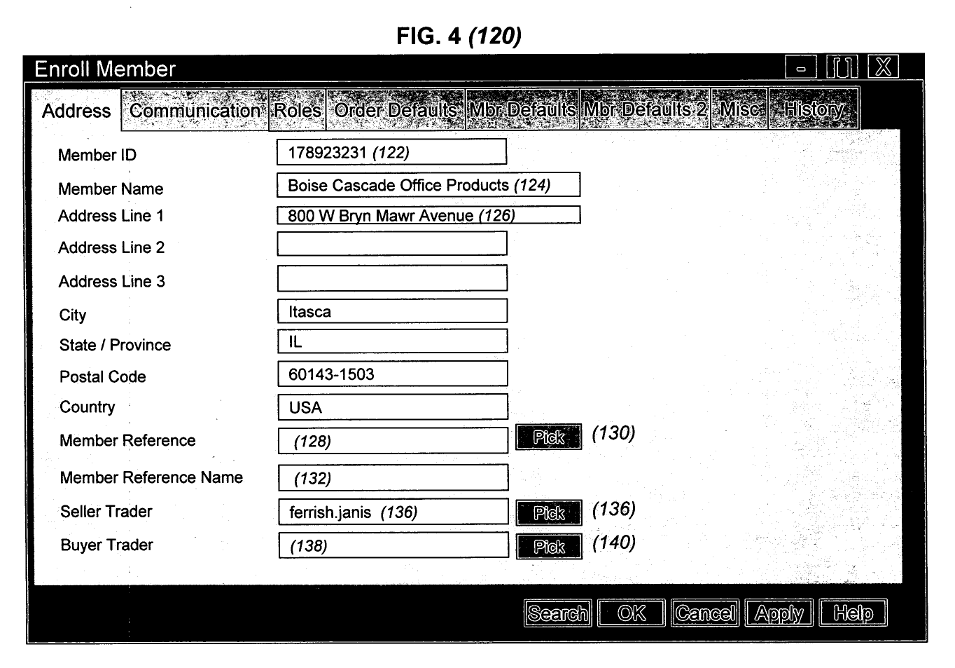

Similar to the exemplary embodiment graphical user interface illustrated in FIG. 2, it is preferable to provide a user with an easy method to enter data into the system. This can be implemented using the graphical user interface shown in FIG. 4. FIG. 4 is an exemplary embodiment of a graphical user interface which a trader may see when establishing the member data illustrated in FIG. 3. The member ID field 122 holds the unique member ID for this particular member. If the trader is authorized for only one member, the trader ID will automatically be entered in this box. If the trader is authorized to maintain more than one member, the trader must enter member ID number in this box. The member name field 124 contains the name of the member which is referenced by the member ID 122. The address box 126 contained the default address of the member referenced in the member name box 124 and member ID 122. The member reference box 128 and member reference name box 130 contains a reference member ID number and name respectively. The seller trader box 134 contains a name of a default trader contained in this member, should this member be a seller member. The pick button 136 is used so that the trader may view a list of seller traders which can be entered in the seller or trader box 134. The buyer trader box 138 is used to fill in a default trader name should this member be a buyer member. The pick button 140 may be used by the trader to see a list of all traders available to be used in this box. This field is required as each member requires at least one trader to become established within the community. There may be more than one trader within each member, however this is tables defines a default trader for this member.

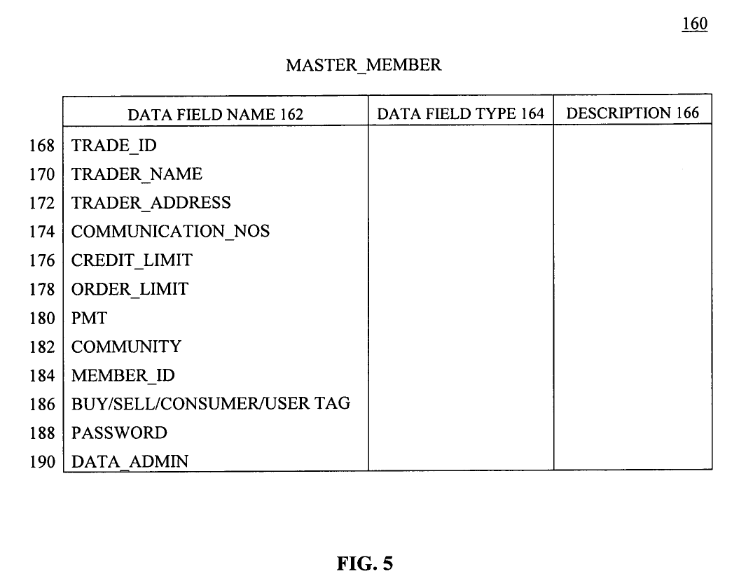

In an exemplary embodiment of the present invention, it is useful to define a trader by establishing certain parameters within a data table. FIG. 5, is an exemplary embodiment of the master trader table 160. The table comprises 3 columns, data field name 162, data field type 164, and description 166. The trader ID field 168 contains a unique ID number for the particular trader to which this table pertains. The trader name field 170 contains an alpha numeric representation of the trader ID so that users may refer to a name rather than an unique ID number when referring to this trader. The trader address fields 172 contain a default address for the trader to which this sample pertains. The communication numbers field 174 represents a series of fields which contain various phone numbers, fax numbers, e-mail addresses etc. for this particular trader. The credit limit field 176 contains a number which represents a high credit limit for this particular trader. The order limit field 178 contains a number which represents the maximum amount of orders this trader may place should this trader be a buyer. The payment field 180 contains the standard payment terms for this trader should this trader be a buyer. The community field 182 contains a default community name for this trader. Please note that a trader may belong to multiple communities. The member ID field 184 contains a default member ID of the member to which this trader belongs. Please note that a trader may belong to multiple members as well. The buy, sale consumer user flag field 186 contains a flag in the proper field should this trader be a buyer, a seller, a consumer or simply a system user. The password field 188 contains a password that this trader must use to sign in on the system. The data administration field 190 contains a plurality of fields that are used for typical data administration.

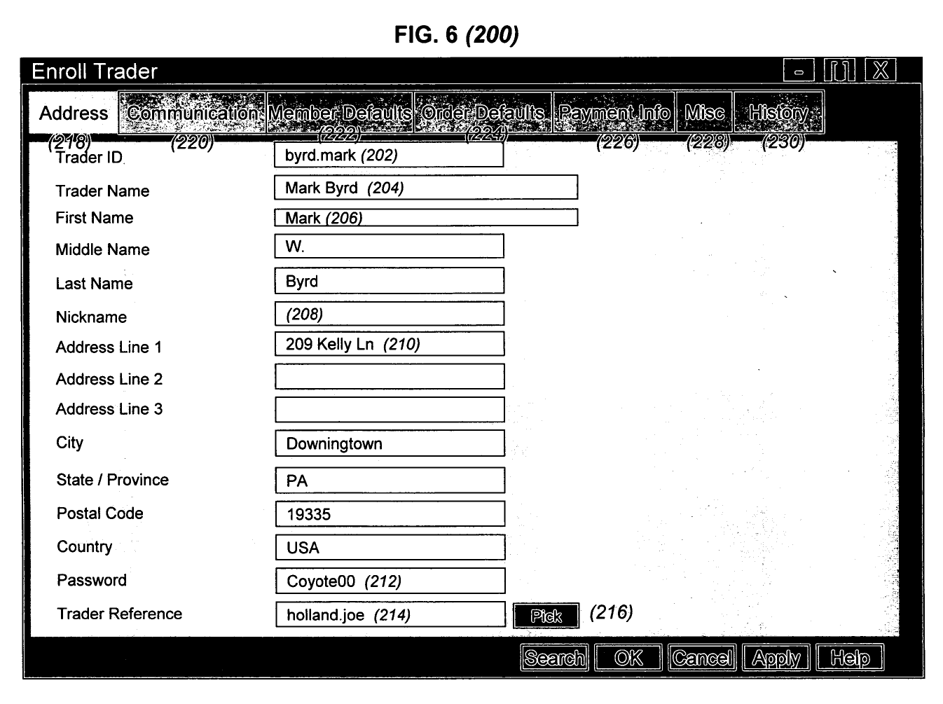

In order to allow a user to enter data into the master trader table in an exemplary embodiment of the present invention, a graphical user interface is provided therein which a user can enter data. FIG. 6 is an exemplary embodiment of a graphical user interface 200 used by a trader to maintain other trader data. The trader ID field 202 is used to show the ID of the trader that is being maintained. The trader name 204 holds the name of the trader referred to by the trader ID. The first, middle, last name fields 206 hold the first, middle and last name of the trader being maintained. The nickname field 208 contains the nickname of the trader being maintained. The address field 210 contain the default address for the trader being maintained. The password field 212 contains a password used by the trader being maintained in order to access the system. The trader reference field 214 contains the name of reference traders. The pick button 216 next to the trader reference field 214 is used to display a listing of traders which can be entered into the trader reference field 214. Moving now across the top of the screen, the address button 218, which is pressed in this exemplary embodiment, is used to display the fields pertaining to the trader's addresses. The communication button 220 would be pressed to display the fields pertaining to the communication data as described in FIG. 5. The member default button 222 would be pressed to display the default identification data for this particular trader, which comes from the member to which this trader belongs. The order default button 224 is used to display the fields which contain information regarding this trader's ordering preferences. The payment button 226 is used to display fields regarding how this trader pays, payment, terms, shipment terms, etc. The miscellaneous button 228 is pressed to display fields which are not displayed by the remaining buttons. The history button 230 is pressed to display the history of this particular trader.

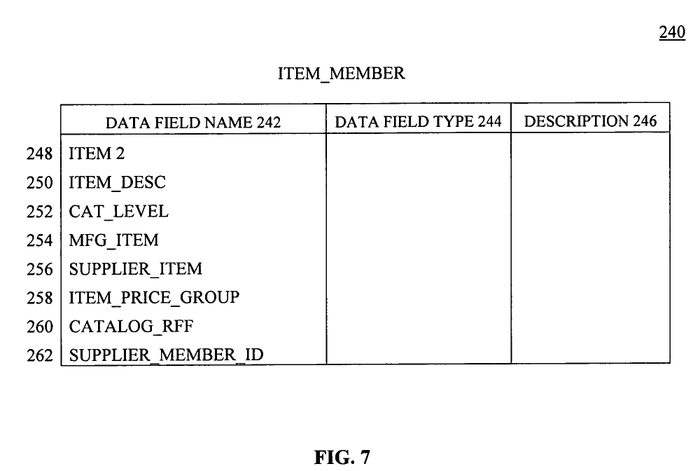

In an exemplary embodiment of the present invention, it is useful to maintain a master item in a data table format. FIG. 7 is an exemplary embodiment of the item master 240. The table contains three columns, the data field name 242, the data field type 244, and the description 246. The item field 248 contains a unique ID number for the particular item to which this master list pertains. The item description field 250 contains a text description of the item. The category level field 252 contains a number which represents the category level of this item. The manufacturer item 254 contains the manufacturers part number for this item. The supplier item field 256 contains the supplier part number for this item. Please note that the item number 248 the manufacturer's item number 254 and the suppliers item number 256 need not be the same number. The item price group field 258 contains the price group to which this item belongs. The catalog reference field 260 contains a page number for the catalog in which this item may appear. This field may also contain a web address which contains a description of the item. The supplier member ID field 262 contains the unique member ID to which this item is associated.

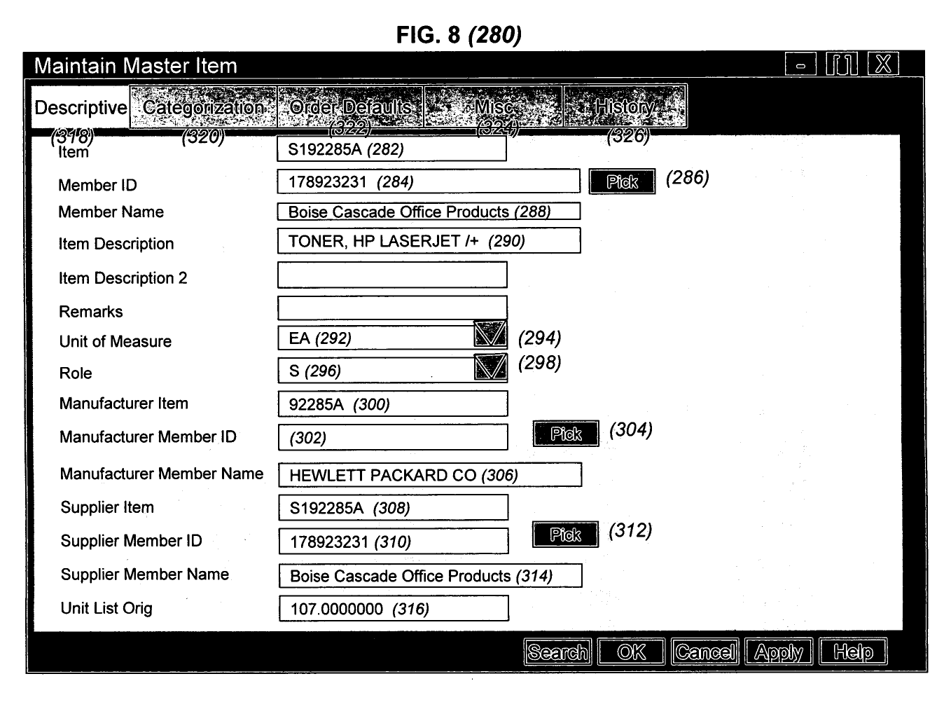

Similar to the other data tables, it is useful to provide a graphical user to enter data into a master item list. Turning now to FIG. 8 there is shown an exemplary graphical user interface which a trader may use to maintain data in the master item list 280. The item field 282 holds the unique ID number for the item to which this table pertains. The member ID field holds the unique member ID with which this item is associated. The pick button 286, located next to the member ID field is used to display a list of member ID's with which this item may be associated. The member name 288 holds the member name associated with the unique member ID in field 284. The item description 290 is a text description of the item to which this table pertains. The unit of measure field 292 is used to hold the unit of measure for this particular item. The down-arrow button 294 may be used by the trader to generate a drop down menu of all possible choices for unit of measure. The role field 296 holds the role that this item has been assigned. The down-arrow button 298 can be used by the trader to generate a drop down menu with all the possible role selections for this item. The manufacturer item field 300 holds the manufactures part number for this item. The manufacturer member ID field 302 holds the member ID of the manufacturer, should the manufacturer be a member in this community. The pick button 304 located next to the manufacturer member ID field 302 is used by the trader to view a list of all possible choices of member ID's. The manufacturer member name field 306 contains the name of the manufacturer should this manufacturer be a member as referenced in the member ID field 302. The supplier item field 308 holds the suppliers part number for this particular item, which may be different than the manufactures part number and different then the item number 282. The supplier member ID field holds the member ID of the supplier of this particular item. The pick button 312 located next to the supplier member ID field is used by the trader to display a list of all potential member ID's which a trader may pick for this particular item. The supplier member name field 314 holds the name of the supplier of this particular item. The unit list original field 316 holds the original list price for this particular item. A row of buttons is located across the top of this graphical unit interface. The descriptive button 318 is pressed in this exemplary embodiment and displays the fields related to an item description. The categorization button 320 would be pressed to show fields related to the categorization of the item to which this fields pertains. The order default button 332 would be pressed to display all the fields associated with order defaults. The miscellaneous button 324 would be pressed to display the fields not associated with fields 318, 320 or 322. The history button 326 would be pressed to show the fields associated with the item history.

We have now described exemplary embodiments of data tables which contain data that defines the entities which comprise a community, that is, the members, and the traders who belong to said members. We have also described an exemplary embodiment of a data table that defines a list of items which the members may sell to and purchase from each other, respectively.

Limits are placed on the traders and members in regard to which traders can maintain data for other traders, members, and communities. Also, restrictions are placed on members as to which other members they may transact business with. The following tables are used to define the relationships between traders, members and communities, and to restrict or allow a trader's access to certain data.

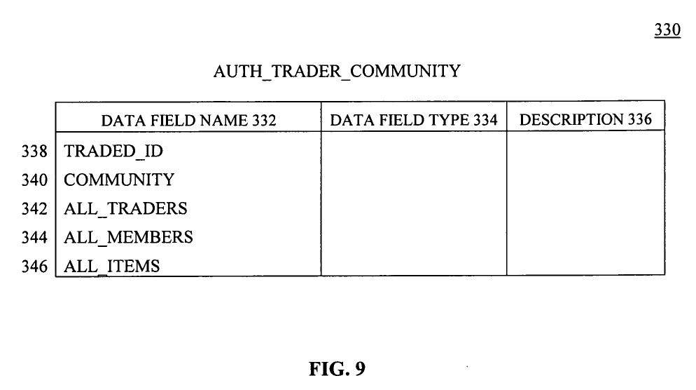

A single data table can be useful maintaining the parameters of a trader to community relationship. Turning now to FIG. 9, there is shown an exemplary embodiment of the trader to community authorization table 330. The table comprises three columns, the data field name column 332, the data field type column 334, and the description column 336. The trader ID field 338 contains the unique ID of the trader to which this table pertains. The community field 340, contains the ID of the community in which this trader is authorized to maintain data. The all trader field 342 is set to positive if the trader to which this table pertains has the authority to maintain data of all traders within the community. The all members field 344 is set to positive if the trader to which this table pertains has the authority to maintain data for all members in this community. The all items field 346 is a positive if the trader to which this table pertains is authorized to view all of the items belonging to the members that this trader is authorized to in this community.

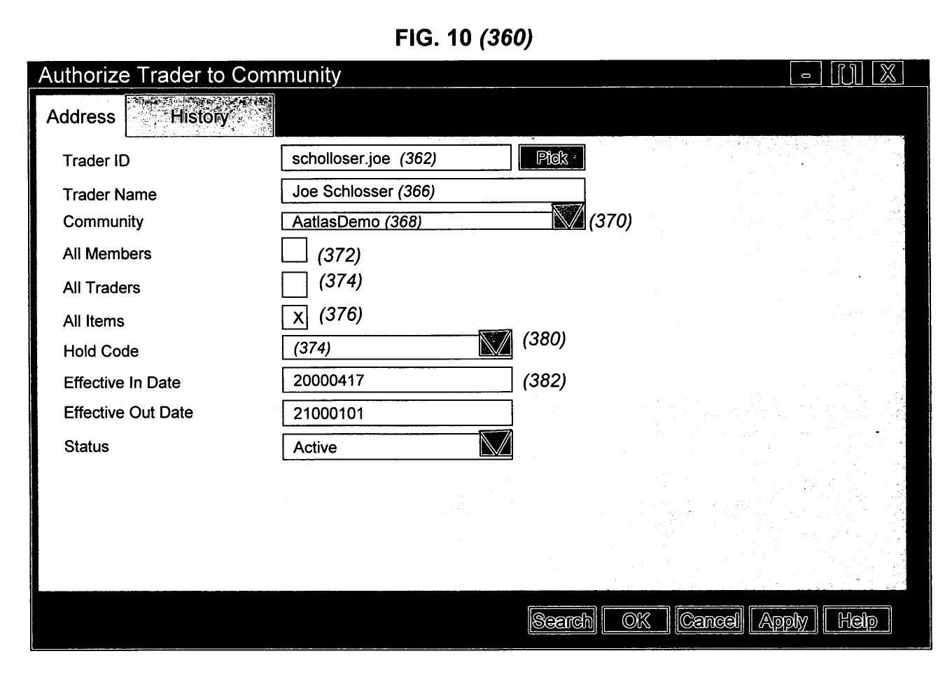

Should a user desire to maintain data, that is add, delete or modify the data in an exemplary authorization table, it is useful to provide the user a graphical user interface. FIG. 10 is a representation of an exemplary embodiment of a graphical user interface which a trader may use to establish trader to community authorizations 360. The trader ID field 362 contains the unique ID of the trader to which this table pertains. The pick button 364 may be pressed by the user to display a list of trader ID's that may be used in the trader ID field 362. This list represents all the trader ID's to which the trader maintaining this data has access. The trader name field 366 contains the full name of the trader to which this table pertains. The community field 368 contains the name of the community to which this trader is being authorized. The down-arrow button 370 may be pushed by the trader who is maintaining this data, to see a drop down menu containing the names of all the communities which may be entered into the community ID field 366. The next three boxes 372, 374 and 376 are used to authorize the trader to maintain data for all members, all traders, and/or all items, respectively. These authorizations are within a particular community. The balance of the text boxes 378 and 382 are used to display status and conditions of the data table.

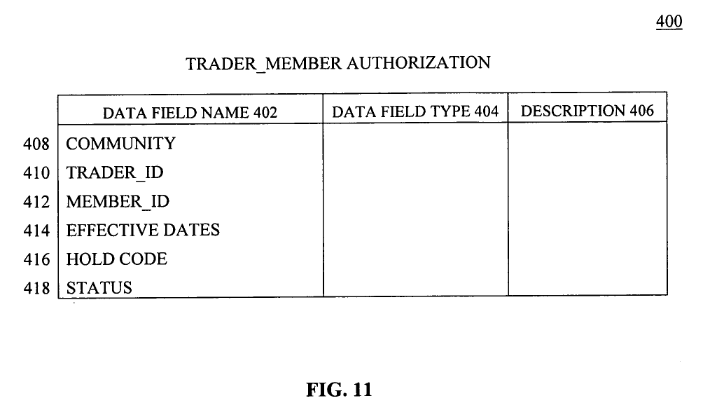

In an exemplary embodiment of the present invention, parameters that define the trader to member relationship may be kept in a data table. Turning now to FIG. 11, there is shown an exemplary embodiment of the trader member authorization table 400. The table consist of three columns: data field name 402, data field type 404 and description 406. The community field 408 contains the name of the community in which this trader is authorized to participate. The trader ID field 410 is the ID number of the trader to which this table pertains. The member ID field 412 contains the unique identification number for the member which this trader is authorized to maintain data for. Effective date fields 414 and 416 represent the date at which this table becomes effective and the date at which this table becomes effective. Hold code field 416 contain a code representing a reason for this authorization to be on hold should this authorization indeed be on hold. The status field 418 contains an active/inactive status which describes the status of this authorization.

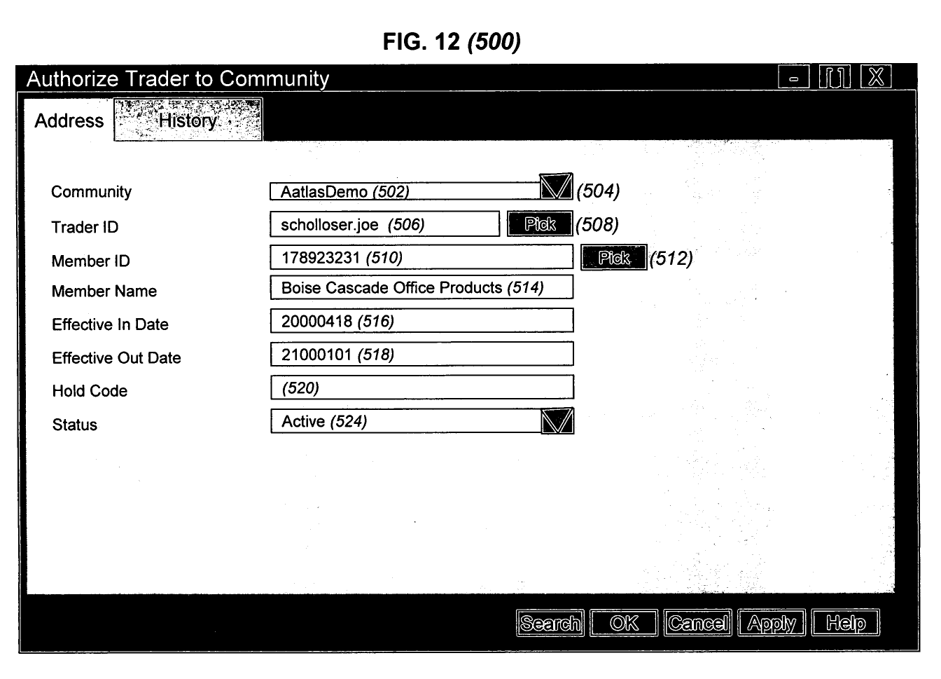

As with the other data tables desirable herein, it is useful to provide a user with a graphical user interface to access data. FIG. 12 represents an exemplary embodiment of a graphical user interface used by a trader to establish trader to trader authorizations. Community field 432 contains the name of the community in which this authorization is valid. The down arrow button 434 next to community field 432 may be pressed by the trader to activate a drop down window which contains the name or names of the communities in which this trader may establish trader to trader authorizations. The from trader field 436 contains the name of the trader for which that the user is establishing authorization. Pick button 438 next to the from trader field 436 may be pressed by the user to display a list of traders from which the user can pick. The from trader name field 440 represents the name associated with the trader ID in the from trader field 436. The to trader field 442 represents the unique ID for the trader which the user is establishing as the trader who's data will be maintained by the from trader. Pick button 444 may be pressed by the user to show a list of all traders possible for the to trader field 442. The user may pick a name off of the list to be entered into the to trader field 442. The to trader name field 446 is the text representation of the to trader ID in the to trader ID field 442. The effective in date 448 and the effective out date 450 represent the date this information becomes effective and the date this information becomes invalid, respectively. The hold code field 452 represents a code which represents a reason for this authorization to be on hold, should it be so. The down arrow button 454 next to the hold code field 452 may be pressed by the user to activate a drop down window from which the user may pick the proper hold code, should one be necessary. The status field 456 holds the status of this authorization, i.e. active, non-active, hold, etc. The down arrow button 458 may be pressed by the user to activate a drop down window which provides a list of all potential status code from which the user may pick the appropriate one.

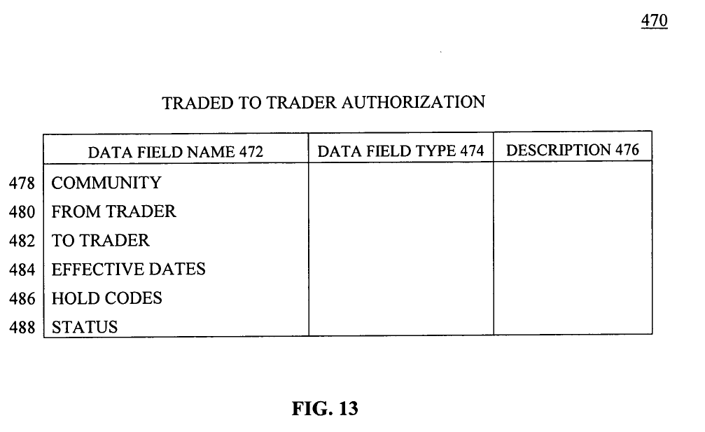

In an exemplary embodiment of the present invention, trader to trader relationship may be defined by parameters as data table. FIG. 13 represents an exemplary embodiment of a trader to trader authorization table 470. The table comprises three column, the data field name 472, the data field type 474 and description 476. The community field 478 holds the name of the community in which these traders are authorized to participate. The from trader field 480 represents the trader that is being authorized to maintain data for another trader. The to trader field 482 represents the trader that the from trader is being authorized to maintain. The effective date fields 484 contain dates at which this authorization table becomes effective and becomes ineffective, respectively. The hold codes field 486 contains codes which represents reasons for which a trader authorization may be on hold. The status field 484 contains the current status of this trader to trader authorization.

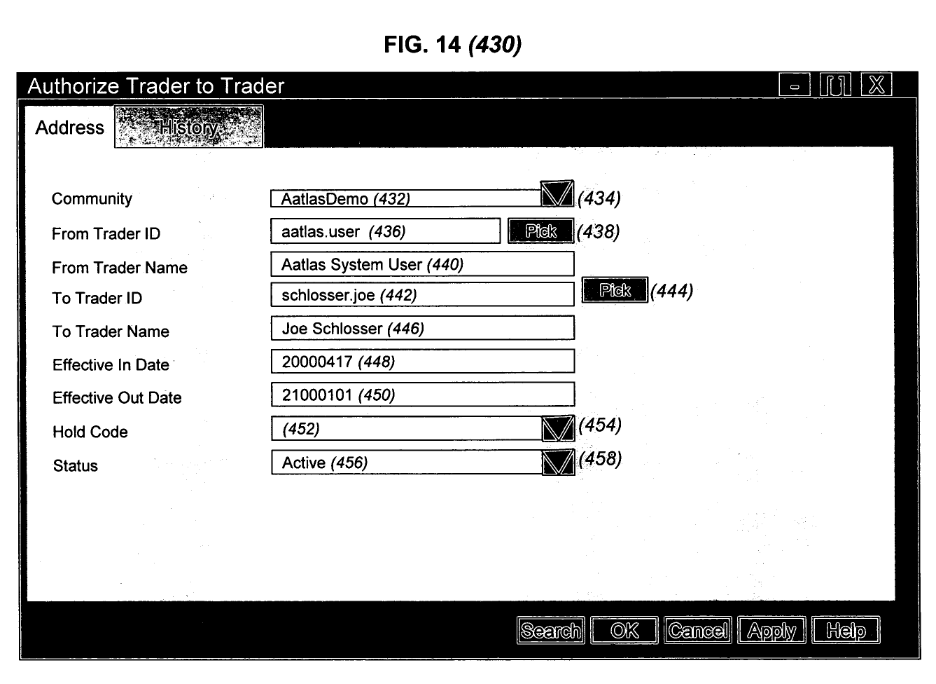

In order to allow a user access to the data, a graphical user interface is helpful. FIG. 14 is an exemplary embodiment of a graphical user interface which a user may use to authorize traders to maintain member data 500. Community field 502 contains the name of the community in which this trader to member authorization is valid. The down arrow button 504 located next to the community field 502 is used to activate a drop down menu which will show all the possible choices for communities for this particular trader. Trader ID field 506 contains the unique ID of the trader that is being authorized to maintain data for the particular member. The pick button 508 located next to the trader ID field 506 is used to display a list of trader ID's which may be entered into trader ID field 506. Member ID field 510 contains a unique member ID number. This member is the member which this trader is being authorized to maintain data for. The pick button 512 located next to the member ID field 510 is used by the user to display a list of all member ID's which may be chosen to fill in member ID field 510. The member name field 514 is the name of the member corresponding to the member ID in number ID field 510. The effective in and effective out dates 516, 518 are the dates which this information becomes effective and non-effective respectively. Hold code field 520 contains a code which represents a reason why this authorization should be on hold if necessary. The down arrow button 522 next to the hold code field 520 is used to activate a drop down window from which the appropriate hold code may be chosen. The status field 524 contains a status of this authorization. The down arrow button 526 located next to the status field 524 is used to activate a drop down window from which the appropriate status code may be chosen.

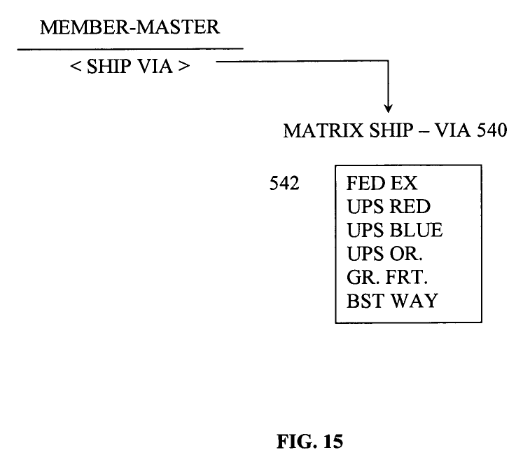

It is appropriate at this time to define a matrix. A matrix is a table of tables. If a certain list of tables is used on a repetitive basis within the system, for various reasons, a matrix may be created and used as a single entity. FIG. 15 is an exemplary embodiment of a matrix table. In member master table 70 there is a ship via field. The ship via field may point to ship via matrix table 540. Within ship via matrix table 540 there are multiple data fields 542. Each of these data fields 542 contains a particular method of shipping, i.e. Federal Express, U.P.S. Red, etc. In this manner, anytime a table requires a ship via field, the matrix table may be inserted rather than repeating each of the specific fields 542 each time this table is required.

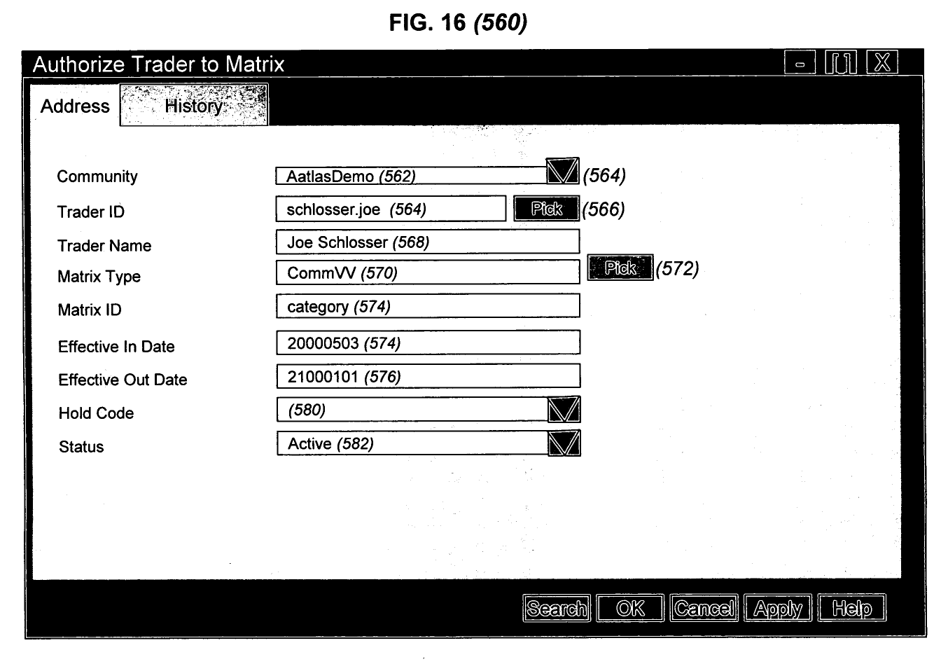

As discussed in reference to other data tables, for a user to add, delete or modify data, it is useful to provide a graphic user interface. FIG. 16 is an exemplary embodiment of a graphical user interface which a trader may use to authorize a particular trader to maintain matrix data 560. The community field 562 holds the name of the community in which this trader is authorized to maintain matrix data. In this example the community is Atlas Demo. The down arrow button 564 located next to the community field 562 is used by the trader to activate a drop down window which will show all the potential communities which this trader may pick from these communities in which this trader is authorized to maintain matrix data. The trader ID field 564 contains the unique ID of the trader which is being authorized to maintain matrix data. The pick button 566 located next to the trader ID field 564 may be pressed by the user to display a list of traders ID's which may be placed in trader ID field 564. The trader name field 568 contains the name of the trader associated with the unique trader ID in the trader ID field 564. The matrix type 570 is the type of matrix which the trader is authorized to maintain. The pick button 572 located next to the trader matrix type field 570 may be pressed by the user to display a list of matrix types from which the user may choose. The matrix ID field 574 contains the unique ID of the matrix which this trader is being authorized to maintain data within. The effective date fields 576 and 578 contain date which show when this authorization is effective and when it stops being effective respectively. The hold code field 580 and the status field 582 operates similar to other hold code fields and status fields within previously described graphical user interfaces.

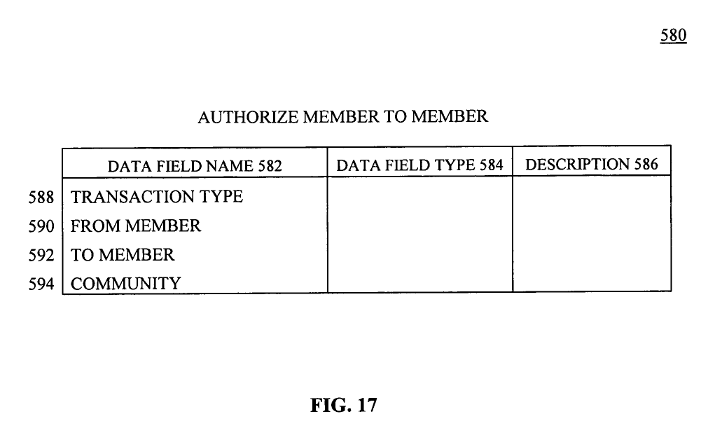

Turning now to FIG. 17 there is showing an exemplary embodiment of a member to member authorization table 580. This table contains three columns, data field name 582, data field type 584, and description 586. The transaction type field 588 contains the type of transaction in which this authorization is valid. Please note that the member to member authorization is a transaction based authorization, whereas all other authorizations are data maintenance based authorizations. This member to member authorization permits certain types of transactions between members within a community. The from member field 590 contains the name of the member that is being authorized to perform the transaction. The from to member field 592 contains the name the member that the to member is authorized to transact business with. The community field 594 contains the name the community in which this member to member authorization is valid.

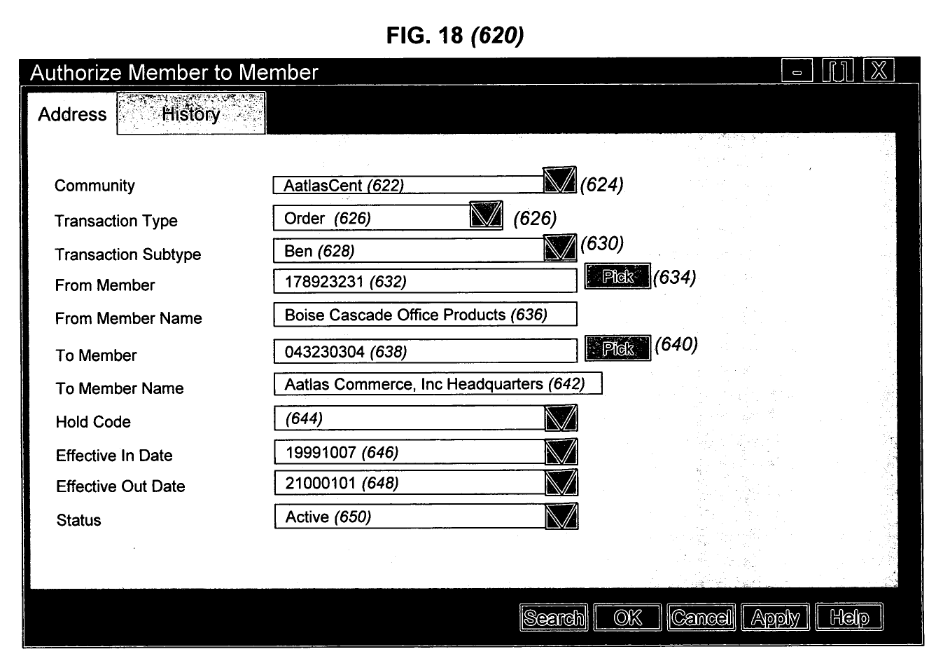

FIG. 18 is an exemplary embodiment of a graphical user interface 620 which a system user may use to authorize members to members. The community field 622 contains the name of the community in which this authorization is valid. The down arrow button 624 located next to the community field 622 may be pressed by the user to activate a drop down window which contains the names of all the communities which may be chosen for this field. The transaction type field 626 contains the type of transaction which is being authorized between two members. The down arrow button 628 located next to the transaction type 626 may be pressed by the user to activate a drop down window which show a list of all choice available for this user to pick from. The transaction subtype field 628 contains the type of the transaction type which is being authorized in this member to member authorization. The down arrow button 630 located next to the transaction subtype field 628 may be pressed by the user to activate a drop down window which contains all of the users choices for this field entry. The from member field 632 contains a unique ID number of the member which is being authorized to transact business in this community, in this screen. The pick button 634 located next to the from member field 632 may be chosen by the user to display a list of all member ID's from which the user may choose. The from member name 636 is the textural representation of the from member ID. The two member field 638 contains the unique ID number for the member which this user is authorizing another member to transact business with the pick button 640 located to next to the to member field 638 may be chosen by the user to display a list of all potential member ID's which may be used to fill in this box. The to member name 642 contains the text representation of the to member ID in the to member field 638. The remaining fields hold code 644 effective date 646 and 648 and this field 650 all function similar to other graphical user interfaces described herein.

Now that the data tables have been described and the authorization tables have been described, it is now appropriate to describe how these tables interact so that a user of the system may restrict viewing or maintaining data that they are specifically authorized to view or maintain. In other words, a user of the system who, in this exemplary embodiment is a trader, may be authorized to maintain data for other traders, other members, or the community. This trader may be authorized to maintain all data, or just a portion of the data. Whether or not a trader has authority to maintain data for another trader, another member, or the community is determined as the trader uses the system. It is determined by comparing the authorization tables with the master tables at the time the user, or trader, is using the system.

This determination is accomplished by establishing a virtual table called a view. The view is a subroutine which is called into use each time a trader, or a user of the system, wants to maintain data for another trader, another member, or the community.

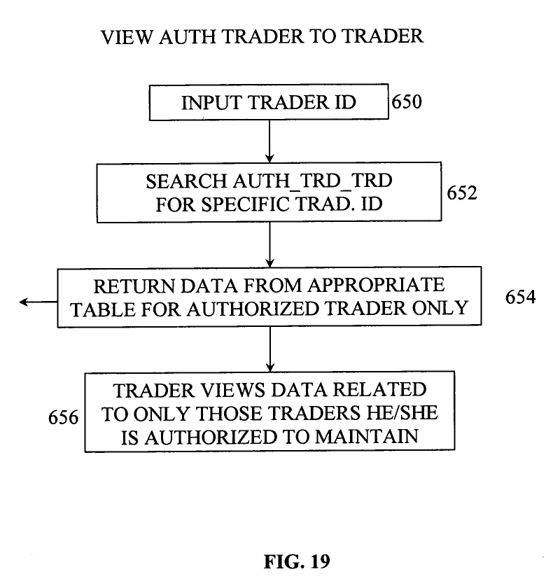

FIG. 19 is a flow chart of an operation of a view. This exemplary view determines the relationship between traders. At step 650, the trader ID is input into the system. This is the trader ID of the current user. At step 652 the trader to trader authorization table is searched for the specific trader ID. If the trader to trader authorization table shows that the trader ID of the user is authorized to maintain trader ID's of other traders, a list of the trader ID's which this trader is authorized to maintain is displayed on the system. At step 656, the trader that is currently using the system, and maintaining data, views only the data associated with the trader ID's that this particular trader is authorized to maintain.

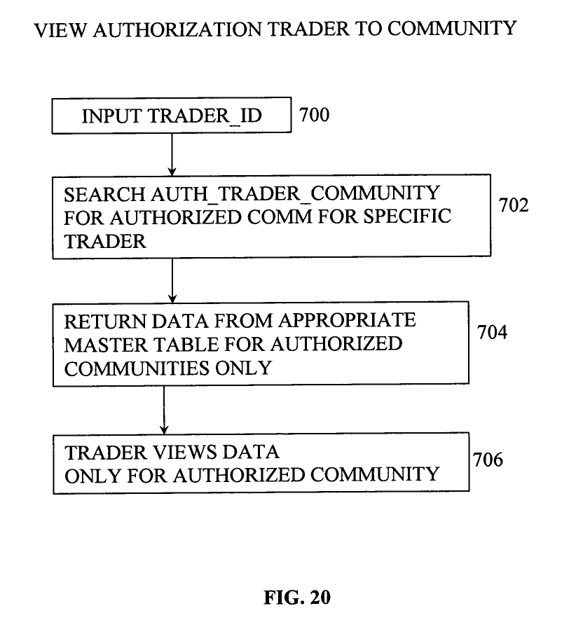

FIG. 20 is a flow diagram of an exemplary embodiment of the trader to community authorization view of the present invention. The view will determine the relationship between a trader and a community. The trader ID of the user of the system is input in step 700. In step 702, the trader to community authorization tables are searched for the particular trader ID that has been input into the system. At step 704, the system returns data for the communities for which this trader has been authorized to maintain data. In step 706, the trader views only the data associated with the communities which this trader is authorized to main data for.

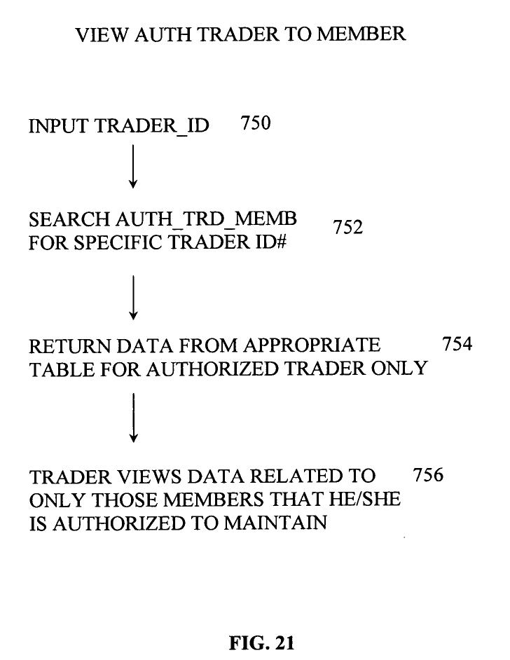

FIG. 21 is a flow diagram of an exemplary embodiment of the trader to member authorization view of the present invention. This view will determine the relationship between a trader and a member. First, at step 750, the trader ID is input into the system. At step 752, the trader to member authorization tables are searched for the specific trader ID. At step 754, data is returned to the trader associated with the from the members which this trader is authorized to maintain. And at 756 the trader views the data related to the members that this trader is authorized to maintain. Please note this data is only those members which this trader is authorized to maintain.

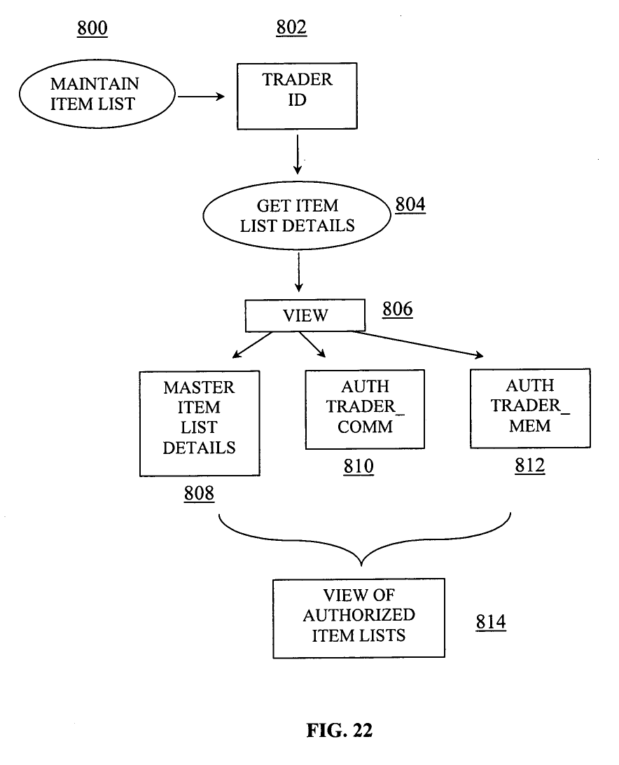

In an exemplary embodiment of the present invention, it is useful to provide the ability to do add, delete or modify data. This is referred to as data maintenance and may be implemented, for example, in accordance with the flow chart of FIG. 22. FIG. 22 is a flow diagram representing an exemplary embodiment of the steps required to do a data maintenance. In particular, FIG. 22 represents steps required for maintaining item lists. In step 802, the trader ID of the user who is going to maintain an item list is input into the system. At step 804, the item list details are retrieved from the master item list table. At step 806, a view is created that compares the master item list details with the trader to community authorization table and the trader to member authorization table. The trader to community authorization table and the trader to member authorization table are compared using the trader ID, input in step 802, to retrieve the communities and members which this trader is authorized to maintain. Those traders and members are then compared to the master item list so that the master item list details 808 only pertaining to the authorized communities and authorized members are returned to the user/trader so that at step 814 the user/trader will view a list of item lists that he or she is authorized to maintain.

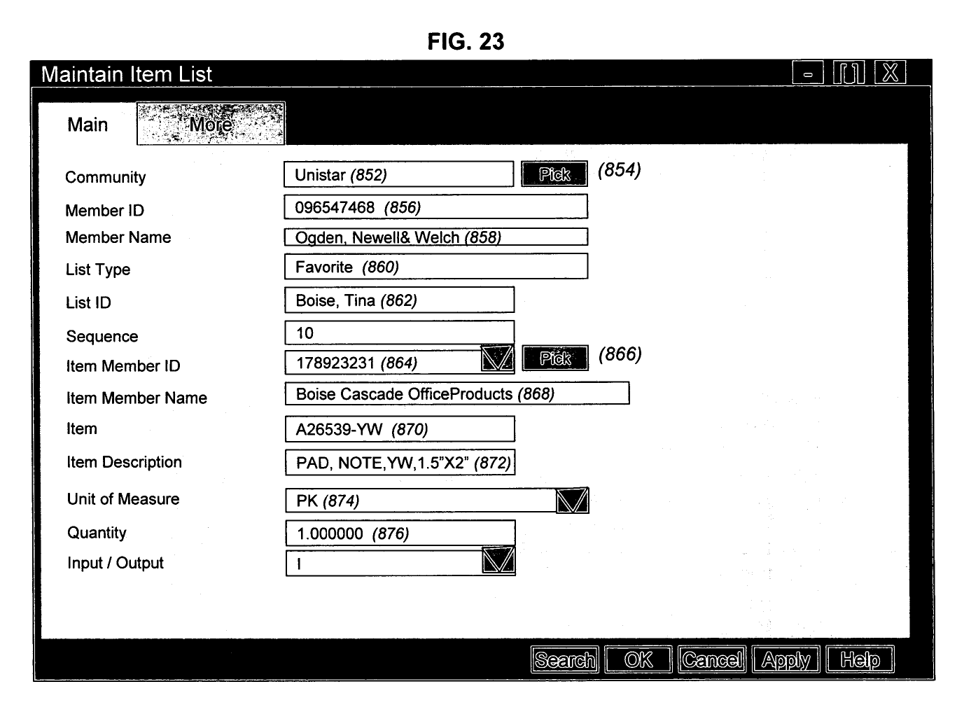

Maintaining data is typically required of any system using data tables. In order to add, delete or modify a data table, for example, an item list table, it is useful to provide a graphical user interface for a user, which may be implemented, for example, in accordance with FIG. 23. FIG. 23 is an exemplary embodiment of a graphical user interface that a user will use and see when maintaining an item list 850. The user will input a name of a community in field 852. The user may press the pick button 854 located next to the community field 852 which will display a list of communities which the trader is authorized to maintain. The member ID of the member which this trader is going to maintain is input in field 856. In field 858, the text name relating to the member ID in field 856 is displayed. The list type 860 is the type of the list which this trader wishes to maintain. The list ID 862 is the ID of the list which this trader is going to maintain. The item member ID 864 is the ID of the member to which the item belongs. The pick button 866 located next to the item member ID field 864 may be pressed by the user to pick from a list of item member ID that are available for user to pick from. The item member name is the text name associated with the item member ID. The item 870 is the actual item number which the trader is maintaining on the item list. The item description is the text description relating to that particular item number. The unit of measure 874 is the unit of measure in which this item is sold or purchased. The quantity 876 is the quantity which is being entered into this item list.

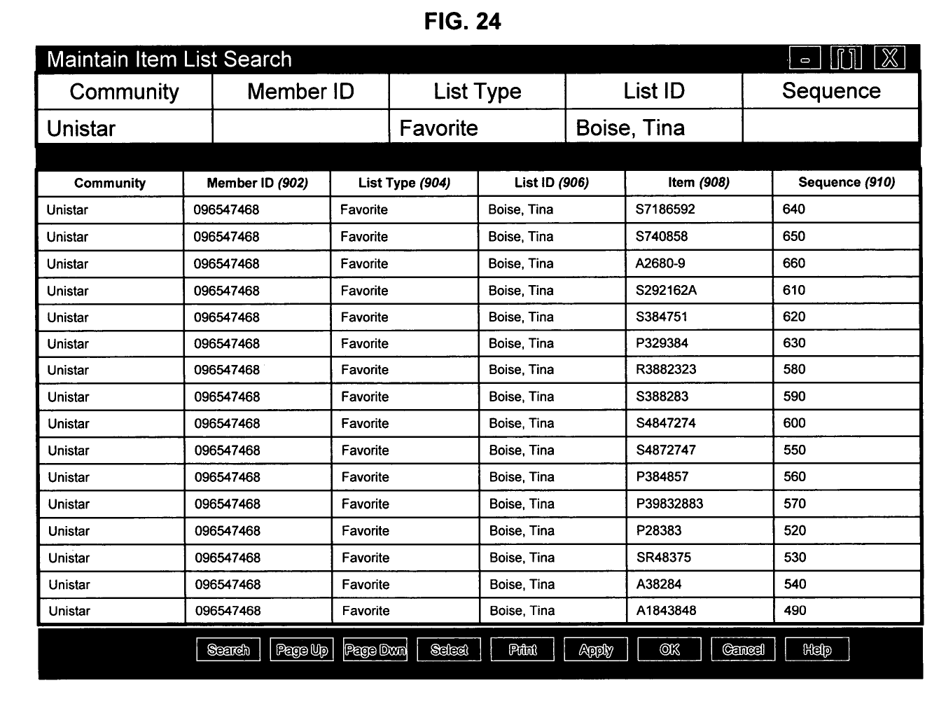

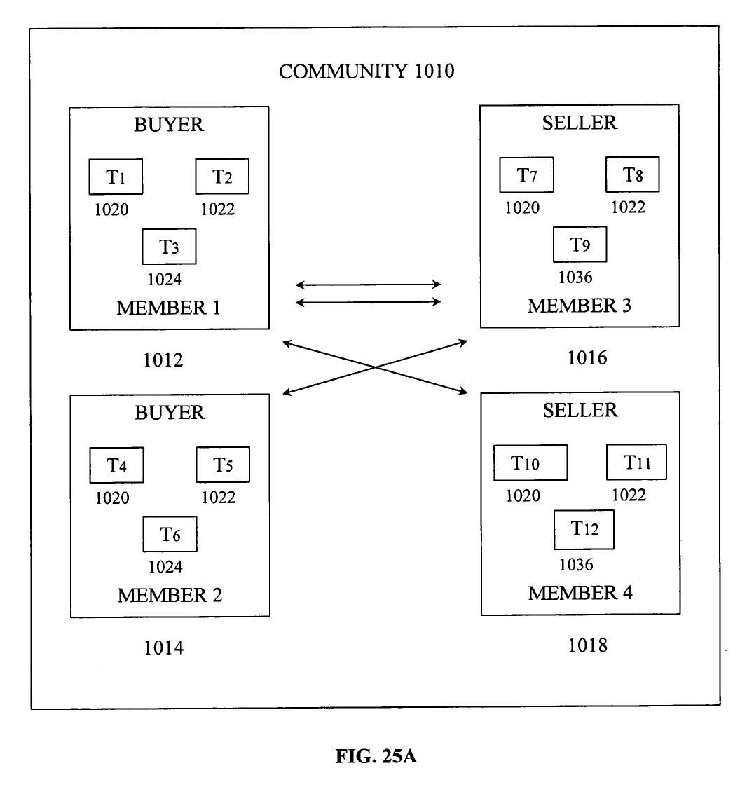

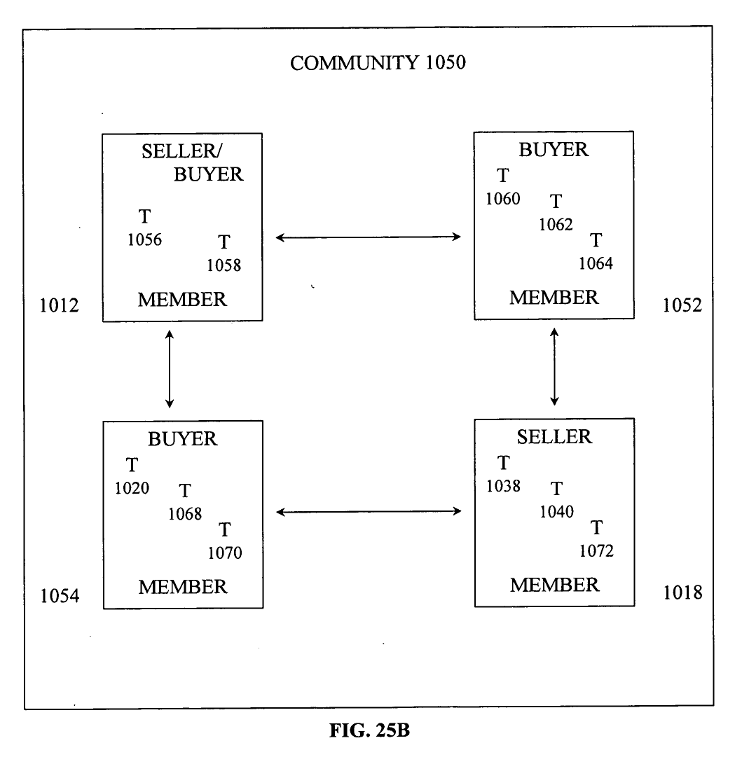

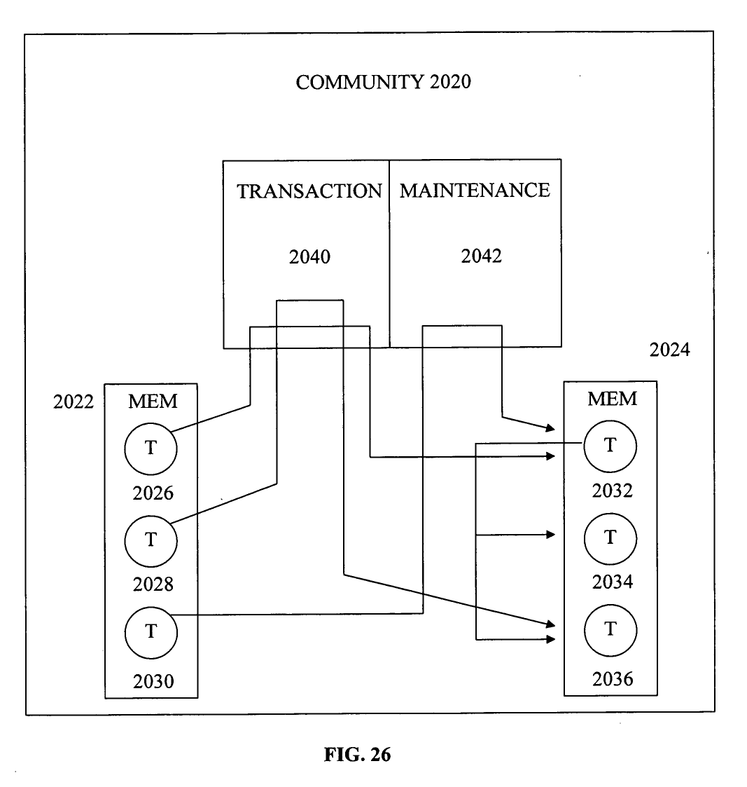

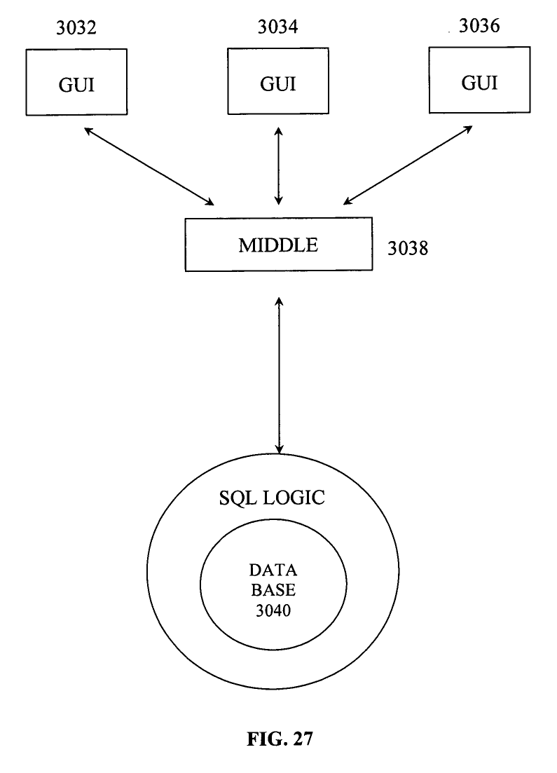

FIG. 24 is an example of a GUI of a search performed on the maintain item list. The search results show this particular trader's authorized community 900, member ID 902, list type 904, list ID 906, items 908 and a sequence 910. This table is formed by the method illustrated in FIG. 22.

1. A computer implemented method for controlling a commercial environment, said commercial environment comprising a plurality of traders, each of said traders included in at least one of a plurality of members, wherein said plurality of members are included in at least one of a plurality of communities, said method comprising the steps of:
establishing an on-going on-line business to business exchange with rules governing transactions between the plurality of communities, members and traders in a structured environment;
dynamically defining which of said plurality of members in the business to business exchange are included in at least one of said communities to flexibly control transactions in the on-line business to business exchange;
dynamically defining which of said plurality of traders in the business to business exchange are included in which of said plurality of members to flexibly control transactions in between said plurality of members, and
allowing at least one of said traders to authorize at least one of
a) interaction between a first of said traders and a second of said traders, and
b) interaction between a first of said member and a second of said members.

2. The method of claim 1, further comprising:
designating at least one of said communities in which said first and second of said traders are allowed to interact, wherein interaction between said first and second of said traders is prohibited unless said first and second of said traders belong to said designated community.

3. The method of claim 1, wherein ones of said members are included in more than one of said communities.

4. The method of claim 2, further comprising the step of:
allowing said ones of said traders to authorize interaction between any of said traders and ones of said members.

5-22. (canceled)

23. The method of claim 1, further comprising the step of assigning a sponsor to each of the plurality of communities, wherein the sponsor organizes, selectively maintains, and selectively controls the assigned community.

24. The method of claim 1, further comprising the step of creating dynamic individual definitions for each community, member and trader, wherein the definitions determine the relationships between various entities and permit flexible interactions between multiple entities.
